(19) United States
(12) Patent Application Publication
(10) Pub. No.: US 2004/0224768 A1
(43) Pub. Date: Nov. 11, 2004

(54) Video game controller with integrated status indicators

(76) Inventors: Saied Hussaini, Miami, FL (US); Marc Iacovelli, Miami, FL (US)

Correspondence Address: LINIAK, BERENATO & WHITE, Suite 240, 6550 Rock Spring Drive, Bethesda, MD, 20817, US

(21) Appl. No.: 10/833,338

(22) Filed: Apr. 28, 2004

Related U.S. Application Data
(63) Continuation-in-part of application No. 10/356,594, filed on Feb. 3, 2003.
(60) Provisional application No. 60/412,804, filed on Sep. 24, 2002.

(51) Int. Cl. A63F 13/00

(52) U.S. Cl. 463/37

(57) ABSTRACT

A video game controller for interaction with a computer gaming unit. The video game controller comprises a hand held body, a plurality of buttons logistically positioned for manipulation by a user and the communication cable operatively connected to the hand held body and provided to transmit operation commands to the computer gaming unit in response to manipulation of the operation members by a user. The video game controller further comprises an integrated LED indicator light disposed in the hand held body of the controller for illuminating in response to a connection between a communication cable and the computer gaming unit. When the cable is inserted into a receptacle on a computer gaming unit and a connection is properly formed, a LED light formed in the hand held body of the controller will light in response to a voltage across a voltage supply line.

### CROSS-REFERENCE TO RELATED APPLICATION

This application is a continuation-in-part of pending application Ser. No. 10/356,594, filed Feb. 3, 2003 that claims the benefit of provisional application No. 60/412,804 filed on Sep. 24, 2002 and of pending application Ser. No. 10/252,823 hereby incorporated by reference.

### BACKGROUND OF THE INVENTION

1. Field of the Invention

The present invention relates to video game controllers and more specifically to an integrated controller with LED lights to individually indicate the status of a mode of each or a plurality of buttons of a video game controller.

2. Description of the Related Art

Computer video games are well known in the art. Such devices range from small hand held all-in-one units, to larger stand-alone units which interact with stand-alone controllers. For more sophisticated play, stand-alone computer units provide tremendous processing power and work with associated peripheral devices, such as a remote controller and television display in an attempt to bring the player a more dramatic gaming experience to that of hand held devices. A central stand-alone console contains all the essential processing components to run a computer game. A controller is connected to communicate operation control commands from a user. As previously mentioned, this conventional arrangement is well known in the art.

With the tremendous commercial success of stand-alone computer gaming systems, an entire peripheral market has emerged ranging from advanced video controllers, joysticks, steering wheel devices for racing games, multi-tap controllers, vibrating controllers, video stands, audio systems and the like. Programmable controllers are also available which allow a user to customize the operation of control buttons by programming different modes of operation.

With the use of sophisticated controllers that can provide a myriad of functions, a user can forget or get lost when attempting to associate a particular function to a particular key, button, pad, or knob. The current devices available to a user do not provide additional information once a mode selection has been made with reference to a particular button on a video controller.

The prior art utilizes a control circuitry that lights a single LED light when the “turbo” or program (macro) mode is selected for any button on the controller. Normally, controllers have several buttons that are capable of operating in “turbo” mode. The single LED light is lit to indicate when any one of these buttons is in “turbo” or program mode. Thus, a user of this controller would be able to tell that at least one button is in “turbo” mode when the LED light is lit, but would not be able to differentiate which individual button is actually acting under “turbo” or program mode.

It is there necessary to provide a controller that would indicate to a user what special features or modes are empowered to a particular button at a given time.

### SUMMARY OF THE INVENTION

The present invention is directed to a computer game controller with integrated LED display to indicate what special features or modes are in use for a particular button at a given time. A communication cable connects the controller with a stand-alone computer game device. The cable establishes a communication link to facilitate the transmission of command signals. The video game controller of the present invention provides two-way interaction with the stand-alone computer device.

When a user selects button “A” and activates the “turbo” option, a LED light associated with button “A” and located proximate button “A” is lit to indicate that “turbo” mode is engaged for that button.

Yet another object of the invention is to provide a LED light under the surface of the controller. The directional control pads and joysticks have a translucent material disposed thereon to allow the illumination of the LED light to be visible to a user of the controller.

### BRIEF DESCRIPTION OF THE DRAWINGS

FIG. 1a is a top plan view of a controller with integrated LED lights according to a preferred embodiment of the present invention;

FIG. 1b is an additional plan view of the controller showing buttons associated with the controller;

FIG. 2 is a schematic diagram of the components within the controller;

FIGS. 3a-d are plan views of the movement pads located on the controller in FIG. 1;

FIG. 4 is a plan view of the various buttons found on the controller as shown in FIG. 1;

FIGS. 5a-c are plan views of the various plugs used on the end of a communication cable used to connect the controller to a stand-alone computer game device;

FIG. 6 is a plan view of an audio/video cable used to connect the stand-alone computer device to an audio or video output;

FIG. 7 is a top plan view of a controller with integrated LED lights according to an alternative embodiment of the present invention.

### DETAILED DESCRIPTION OF THE PREFERRED EMBODIMENTS

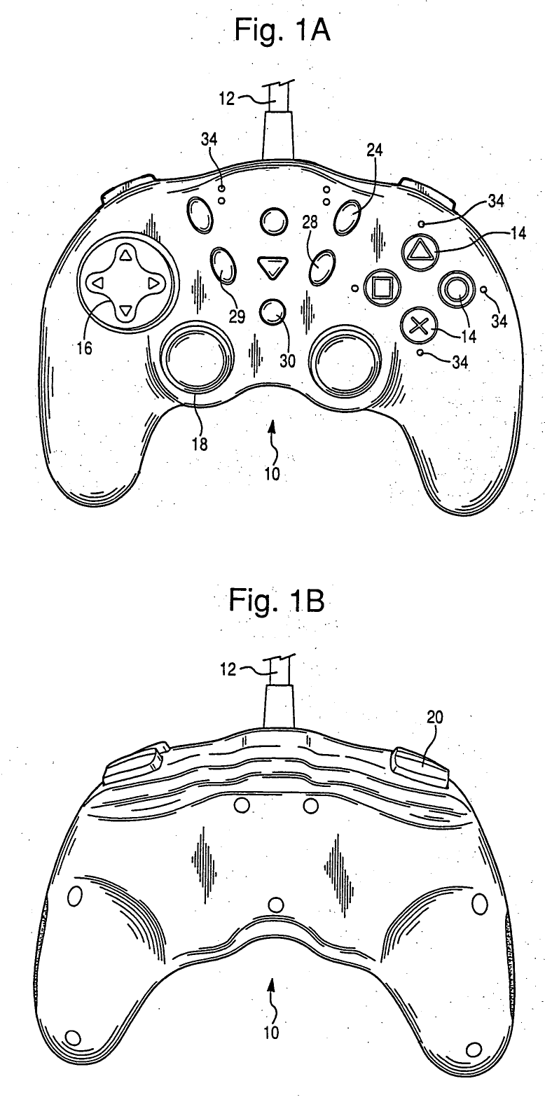

FIG. 1 depicts a video game controller 10 according to a preferred embodiment of the present invention. A video game controller 10 is ergonomically formed to be held by a hand(s) of a user. The video game controller 10 includes a plurality of operating members for manipulation of the users hand to facilitate interaction with game play. The controller may be the programmable type, include a vibratory member for heightened game play as well as lighted buttons etc. A communication cable 12, details of which will be explained later, is also provided to facilitate communication with a stand-alone computer gaming unit (not shown). Such controllers and operating members are well known and within the knowledge of one of ordinary skill in the art.

The video game controller, as seen in FIGS. 1a and 1b, includes a plurality of buttons 14, pads 16, sticks 18, and triggers (shoulder buttons) 20.

Video game controllers have various buttons to implement several modes of operation within the controller 10. The video game controller 10 and the computer gaming unit contain circuitry and drivers to effectuate the commands given from a user to the computer gaming unit via the video game controller 10.

For example, a start button 24 is used to start a video game once the computer gaming unit is turned on. Usually an opening screen appears to the operator on a display device. Another example of a button with specific functions is the select button 28. The select button 28 allows a user to scroll through the various options presented by the computer gaming unit.

Often times, each button 14, stick 18, trigger (shoulder button) 20 or pad 10 has a particular command in which it executes. For example, if a user is playing a hockey game loaded on the computer gaming unit, pad 16 would control the movement of the player under the control of the video game controller 10. The other players would be controlled by an additional user through another video game controller or by the computer gaming unit itself. When the user presses upon the button 14 with the square, the player on the display would pass the hockey puck to another player, while if the user presses the button 14 with the triangle, the player to shoot the puck towards the goal. Similarly, the right trigger 20 may allow the player under the control of the video game unit to check, or hit, another player on the screen. Or the button 14 with the circle allows a player to accelerate and move faster than normal. Thus, each button 14, trigger 20, pad 16 and stick 18 has a distinct function assigned to it.

Many games allow a user to select a “turbo” mode for a particular function. It is often desirable to have a particular function at an accelerated speed or provide an additional power boost to the action on the display. Thus, a user will effectuate the “turbo” or program mode through activation of the “turbo” button 30. For example, when the hockey player in the above example is skating and the user wishes to activate the “turbo” function, he might hold down button 14 with the circle on the top while simultaneously pressing the “turbo” button 30. This would essentially place the circle button 14 in “turbo” or program mode. When circle button 14 is in “turbo” mode the player may skate faster than if circle button 14 was pressed while not in “turbo” or program mode. Thus, a particular button may be selectively programmed in either normal or “turbo” modes.

With the myriad of buttons, triggers, sticks, and pads, a user can forget the status of the various buttons and which mode is engaged or activated at any particular time. Add into the situation the complexity of computer games and the flow of information from the display to the user, it is easy to comprehend how a user can become disoriented when attempting to discern which functions have been turned on and which have not. This could adversely affect the player's ability to play the game.

Conventional controllers use a single LED indicator to specify if any button is specially programmed at a given time. This does not assist current users, as the LED indicator is not associated with a single button, but rather simply indicates when at least one button is activated.

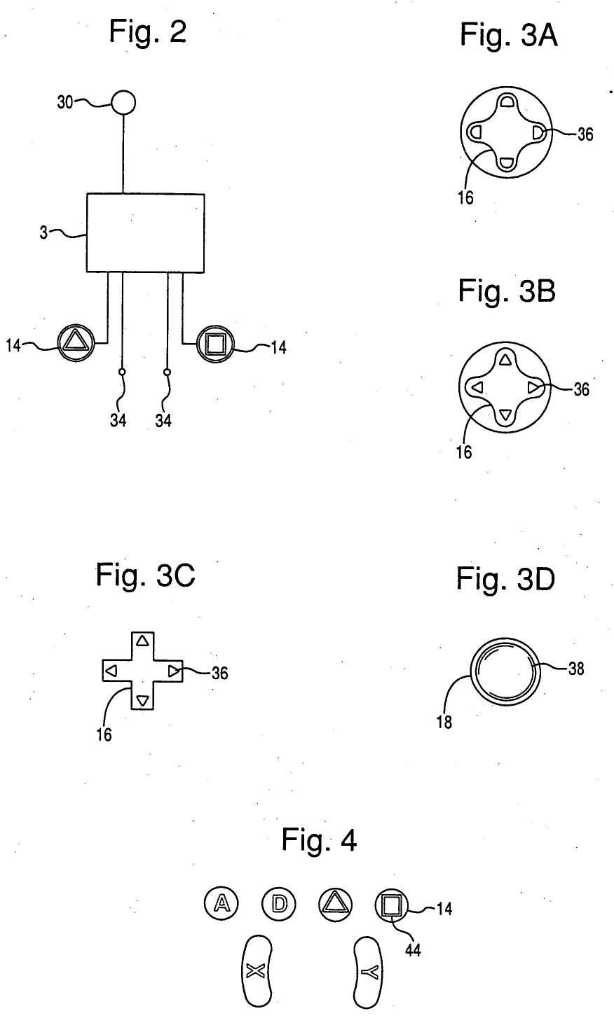

The present invention overcomes this disadvantage by associating a LED indicator or light 34 to each and every button 14 on the controller 10 capable of different modes of operation. When a user or operator selects or programs the “turbo” option to a specific button, an LED light associated with that button is lit to indicate that “turbo” or program mode is programmed at that time. According to FIG. 2, a user depresses the “turbo” button 30 in conjunction with a button 14, for this example the triangle button. The “turbo” button 30 and the triangle button 14 send a signal to a control circuit 3 located within the controller 10. The control circuit 3, through use of an algorithm, then sends a signal to the LED indicator 34 associated with the triangle button 30.

Thus, as seen in FIG. 1, the video game controller 10 is formed with various LED lights associated with a particular button to indicate the status or mode of operation for that particular button on the video game controller 10.

LED lights 34 are positioned proximate buttons 14 to indicate when a user has activated a special function. Each LED light 34 is lit when its corresponding button 14 has been pressed in conjunction with one of the special feature buttons, such as the “turbo” button 28. Once activated, the LED light 34 can be a steady light or can blink depending on the programming of the video game controller 10. Once the user has turned off the special function, the LED light 34 ceases to be lit.

When playing a game, many users or operators dim or turn off the lights in order to better see the display on which the game is being played. This low light setting makes it difficult for a user to see the controls on the controller. The bodies of conventional controllers are often composed of dark colored plastics. It is therefore preferred that that buttons 14, pads 16 and joysticks 18 are lit in order to assist a user in employing the controller.

Thus, the present invention also lights the other sticks 18 and pads 16, as seen in FIGS. 3a-d. Referring to FIGS. 3a-c, a direction pad 16 is shown in isolation. A directional pad usually controls the direction of an element within the computer game. In the example of the hockey game, movement of the directional pad 16 to the right would facilitate movement of the player on the display under the control of the video game controller 10 to move to the right. The same can be said for use of the sticks 18 as seen is FIG. 2d. The sticks 18 and the directional pad 16 may be used to control the same function within the game. However, choice selection of a user would precipitate whether the stick 18 or the pad 16 is used.

Referring back to FIGS. 3a-c, an LED light is located under the surface of the controller. The direction pad 16 is fit with a translucent material or partially translucent material that allows the light generated by the LED light under the surface of the controller to be seen by a user or operator. The LED light is tied to the circuitry of the controller, so that when a voltage flows through the circuitry, the LED is lit. Is it possible to have LED lights associates with the directional movement of the pad, so that if a user moves the pad to the right, the right LED is lit.

Similarly, the stick 18 is fit with a translucent ring 38 around the outer edge as seen in FIG. 3d. The translucent ring 38 allows the LED light to be visible to the user. The LED light would be located within the body of the stick 18.

In another feature of the present invention as seen in FIG. 4, each button is fit with a translucent material 44 integrally formed with the button. The translucent material or partially translucent material 44 takes the shape of the descriptive symbol on the top surface of the button 14. For example, the circle button 14 would have the translucent material that is shaped as a circle and located within the boundary of the button 14. While in FIG. 1, the buttons 14 are displayed with shapes on the top surface, some controllers utilize letters instead, as is seen in FIG. 4. In this instance the letters, “A”, “B”, etc., would be formed from the translucent material as previously stated. A single LED light is used under the surface of the controller. When the LED light is lit, the light projected is visible through the translucent material 44 on the button 14. The LED light under the surface of the controller is tied into the electrical circuitry of the controller so that when an electrical voltage flows through the controller, the voltage also flows through the LED light.

In some instances, more than one LED light may be used. When the buttons are placed with considerable distance between them on the controller, a single LED light may not be enough to shine through the translucent material for all the buttons. In this instance, more than one LED light may be used.

The LED lights maybe lit using the following technology. Computer gaming units transmit low DC voltage across the communication bundle, located within the communication cable 12, to power circuitry within the video game controller 10. The typical voltage ranges between 3.5 to 5.0 volts. Currently available LEDs do not consume much power and it is preferred to use the incoming low voltage DC source from the computer gaming unit to empower and light the LED lights located within the video game controller 10. Currently, when a user empowers a special mode or programs a special feature on a video game controller, a line of communication is opened up between the particular button (key, pad, stick, etc) and the computer gaming unit. This is usually accomplished via activating a circuitry with in the video game controller. The LED lights formed on the video game controller are tied into these control circuits so that when a line of communication is opened, the flow of current or voltage to the LED light associated to a particular button is also opened up. Thus, the LED light will light up. Similarly, when the user selectively closes the communication line, the voltage to the LED light is cut off by the control circuitry and the light is not longer lit. This technology is commonly known to those skilled in the art.

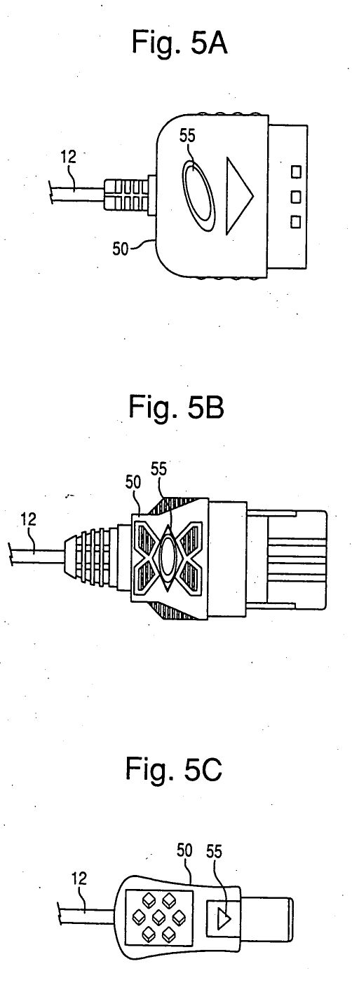

Referring now to FIGS. 5a-c, explanation will be given to the communication cable 12 and the LED display formed in the region of the plug 50. All video game controllers 10 are formed with a communication cable 12 through which the video game controller interacts with the computer gaming unit. The communication cable 12 must be inserted into a receptacle on the computer gaming unit in order to provide a proper connection. Located at the terminal end of the communication cable 12 is a plug 50. The plug 50 is used to connect the communication cable 12 to the computer gaming unit. The plug 50 has a series of electrical connections that correspond to an electrical connection within the receptacle of the computer gaming unit.

Sometimes, the communication cable 12 and the plug 50 can become dislodged, improperly connected, or partially disconnected from the computer gaming unit. This can be caused through several different situations: extreme movement of the communication cable 12 through player excitement, accidental contact with the communication cable, improper insertion of communication cable 12 during connection by the user.

Thus, the present invention integrally forms a translucent material 55 under which a LED light is positioned in the plug 50 to denote the connection status of the communication cable 12 to the computer gaming unit.

The LED light taps into the voltage supply line of the plug to allow the voltage flowing from the computer game to the controller to also flow through the LED light. When a proper connection is made, the LED light will be lit indicating a proper connection. When the connection is broken, the LED light goes out and is not longer visible.

The translucent material 55, as seen in FIGS. 5a-c, can be any shape desirable. In FIG. 5c, a simple arrow is used as the translucent material 55. In FIGS. 5a and 5b, the logos of the companies who made the video game controller 10 are placed on the plug 50 in the form of a translucent material 55. When a connection is made, the logo LED light 55 lights up.

The LED lights are not restricted to any one color, in fact, a plurality of lights may be used to indicate what kind of connection is made with the communication cable 12 and the computer gaming unit. If a satisfactory connection is made, perhaps a blue LED light is lit, while is a partial connection is made, an orange LED light is lit. Similarly, the translucent material 55 may also be of varying colors.

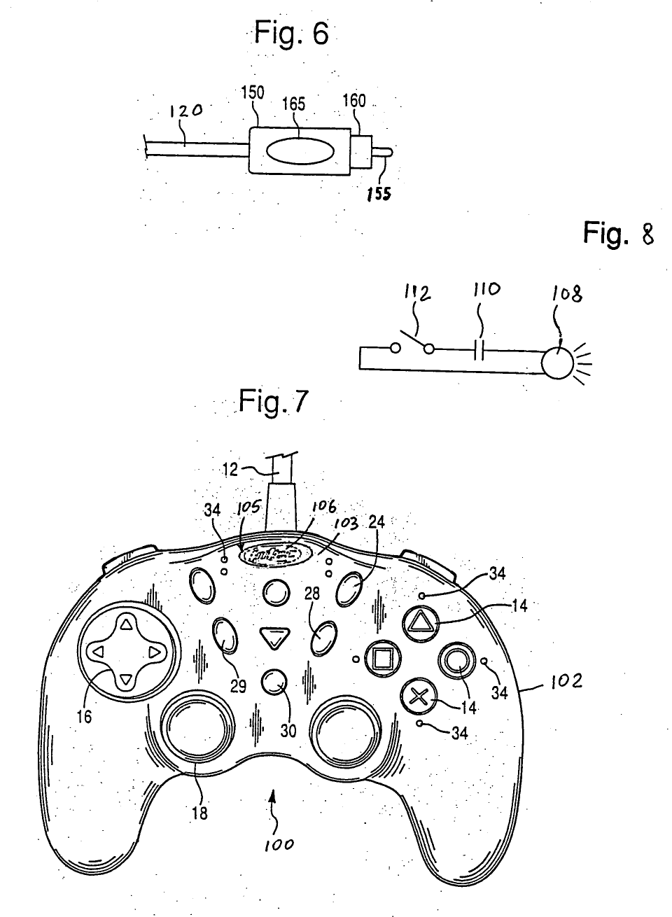

Referring now to FIG. 6, explanation will be given to an audio/video cable 120 and the LED display formed in the region of the plug 150. All video game controllers 10 use the audio/video cable 120 through which the video game interacts a display (not shown) and an audio output device (not shown). The audio/video cable 120 must be inserted into a receptacle on the computer gaming unit in order to provide a proper connection. Located at the terminal end of the audio/video cable 120 is a plug 150. The plug 150 is used to connect the audio/video cable 120 to the computer gaming unit. The plug 150 has a pin 155 that is an extension of a coaxial cable that runs within the audio/video cable 120. Surrounding the pin 155 is a sleeve 160. The sleeve 160 is made from an electrically conductive material.

Sometimes, as with the communication cable 12 above, the plug 150 of the audio/video cable 120 can become dislodged, improperly connected, or partially disconnected from the computer gaming unit.

Hereagain, the present invention integrally forms a translucent material or partially translucent material 165 under which a LED light is positioned in the plug 150 to denote the connection status of the audio/video cable 120 to the computer gaming unit.

The translucent material or partially translucent material 165, located in the plug 150 region of the audio/video cable 120, can be any shape or design.

FIG. 7 depicts an alternative embodiments of the video game controller according to the present invention generally indicated by the reference numeral 100. Components, which are unchanged from, or function in the same way as in the exemplary embodiment depicted in FIGS. 1a and 1b are labeled with the same reference numerals.

The video game controller 100 includes a hand held body 102. The hand held body 102 includes an indicator light 105 covered with an exposed translucent material 106 under which a LED light (not shown) is positioned in the body 102. It will be appreciated that the exposed translucent material may be either clear translucent material or non-clear, or partially, translucent material. The indicator light 105 is provided to denote the connection status of the communication cable 12 to the computer gaming unit. Preferably, the translucent material 106 is formed integrally with an external surface 103 of the hand held body 102 of the video game controller 100.

The LED light taps into the voltage supply line to allow the voltage flowing from the computer game to the controller 100 to also flow through the LED light. When a proper connection is made, the LED light will be lit beneath the exposed translucent material 106 of the indicator light 105 of the controller 100 so that the light is visible to a user through the translucent material 106, thus indicating a proper connection. When the connection is broken, the LED light goes out and is not longer visible.

The translucent material 106, as seen in FIG. 7, can be of any desirable any shape or design. In the embodiment illustrated in FIG. 7, the logo of a company-manufacturer of the video game controller 100 is formed on the translucent material 106 and placed on the hand held body 102 over the LED light. It will be appreciated that any desirable design may be formed on the translucent material 106 of the indicator light 105. When a connection is made, the indicator light 105 lights up illuminating the manufacturer's logo on the translucent material 106.

The LED lights are not restricted to any one color, in fact, a plurality of lights may be used to indicate what kind of connection is made with the communication cable 12 and the computer gaming unit. If a satisfactory connection is made, perhaps a blue LED light is lit, while is a partial connection is made, an orange LED light is lit. Similarly, the translucent material 106 may also be of varying colors.

It will be also appreciated that the whole external surface 103 of the hand held body 102 or only a top portion thereof may be made of the translucent material 106. In this case, when the LED light is lit inside the exposed translucent material of the hand held body 102, the light is visible to the user through the translucent material of the body 102 so that the whole hand held body 102 or, alternatively, only the top portion thereof, is illuminated.

State of the art stand alone computer gaming units transmit low DC voltage through the communication cable 12 to power circuitry within the video game controller 100, power LED lights in operations members, power vibration devices, etc. Such systems are known to supply a three volt source over the communication cable 12. (However, other voltage levels may certainly be utilized.) Such a voltage source may be utilized to illuminate low voltage LEDs in order to illuminate the indicator light 105 shown in FIG. 7, and will now be described with reference to FIG. 8.

FIG. 8 depicts a schematic representation of a light source and primitive circuitry. Preferably a low DC voltage LED 108 is disposed within the hand held body 102 beneath the exposed translucent material 106. When the LED 108 is illuminated, light is transmitted through the translucent material 106. The LED 108 is simply powered by a low voltage source 110 for example as supplied by the gaming unit. Thus, when a proper connection with the gaming unit is made, the LED light 108 will be lit beneath the exposed translucent material 106 of the indicator light 105 of the controller 100 so that the light is visible to the user through the translucent material 106, thus indicating a proper connection. When the connection is broken, the LED light goes out and is not longer visible.

The present invention alternately contemplates providing an additional independent power source to drive the illuminating light when higher intensity lighting is desired or to supplement or replace the voltage source supplied by the gaming unit. In such an instance, one or more standard double AA batteries may be simply disposed within the hand held body 102 and connected to the LED 108. Of course other batteries of different size and voltage may be employed. The LED 108 need only be selected to match the voltage source whether it is supplied from the gaming unit or independent source such as a battery. A switch 112 may also be employed to selectively activate the LED 108 which is particularly desirable when employing an independent battery source. It is to be understood that the particular wiring of the LED light source and configuration within the hand held body 102 is well within the knowledge of one or ordinary skill in the art and therefore will not be elaborated. Only very basic wiring is needed to simply supply the proper voltage to the LED 108.

Furthermore, it should be understood by those possessing skill in the art that various changes and modifications may be made without departing from the spirit and scope of the invention. For example, a blinking circuit may be incorporated to cause the illuminating source to blink in various successive patterns. In such an instance a frequency response signal that activates a vibrating device of the video game controller 100, such as a vibration motor (not shown) disposed within the hand held body 102, may be used to in turn control the voltage source of the LED light 108 and blink or flicker when the vibration motor is activated. A control circuit to blink or activate the light(s) may simply be incorporated into the circuitry shown in FIG. 8 or may be simply activated in response to the activation of the frequency response module. (It is noted that vibration control and the use of such a frequency response module is disclosed in U.S. Pat. Nos. 5,857,986 and 6,135,450 patents incorporated herein by reference.)

While the foregoing invention has been shown and described with reference to the preferred embodiments, it will be understood by those possessing skill in the art that various changes and modifications may be made without departing from the spirit and scope of the invention. For example, in one preferred embodiment the lighting of the indicator or buttons has been described with the use of LEDS. However, electroluminescence (EL) material may be directly and selectively integrated with the surface of the controller material to illuminate the exposed surface and provide the described illumination. Different patterns of EL material may be employed and may further be isolated for selective activation. The use of EL material in other arts is known. A sheet of EL material may be applied to the surface of the controller and electrically connected to the internal circuitry of the controller. Activation of the EL material may be controlled, for example in simple response to a proper connection to the gaming platform as previous described or additional circuitry may be employed for selective activation of individual EL surfaces of the controller. The EL material may also be molded directed into the buttons, indicators, or additional surface of the controller. The shape of the EL material may further be designed to coincide with a LOGO or other design to provide a mood effect. Multiple and separate EL surface may also be integrated onto the top of an individual button and selectively activated to indicate the mode of operation of that control button as programmed. The individual surface need only be electrically connected to a voltage source and control circuitry which may be integrated into the IC of the programmable controllers. In other words, the use of LEDs to backlight the indicator/buttons, may be substituted with EL material. Flexible El sheets may be used to cover a portion to be illuminated. Additional applications are also envisioned by the present invention.

What is claimed is:

1. A video game controller for interaction with a computer gaming unit, said controller comprising:
a hand held body;
a plurality of buttons logistically positioned for manipulation by a user;
at least one communication cable operatively connected to said hand held body and provided to transmit operation commands to said computer gaming unit in response to manipulation of said operation members by said user; and
at least one indicator light illuminating in response to a connection between said communication cable and said computer gaming unit,
wherein said at least one indicator light is disposed in said hand held body.

2. The video game controller according to claim 1, wherein said communication cable includes:
a voltage supply line disposed within said communication cable;
a plug formed on a terminal end of said communication cable to facilitate connection of said voltage supply line between said computer gaming unit and said video game controller;
wherein said indicator light automatically illuminates in response to voltage flow across said voltage supply line when a proper connection is made between said plug and said computer gaming unit.

3. The video game controller according to claim 1, wherein said at least one indicator light is disposed beneath an exposed translucent material such that when said indicator light is illuminated, said light is visible to a user through said translucent material.

4. The video game controller according to claim 3, wherein said translucent material is one of a clear translucent material and non-clear translucent material.

5. The video game controller according to claim 3, wherein said translucent material is formed integrally with an external surface of said hand held body of said video game controller.

6. The video game controller according to claim 3, wherein said translucent material includes an opaque indicia disposed thereon.

7. The video game controller according to claim 6, wherein said opaque indicia is a logo of a company-manufacturer of said video game controller.

8. The video game controller according to claim 3, wherein said at least one indicator light is an LED visible through said translucent material.

9. The video game controller according to claim 3, wherein said translucent material is a colored translucent material.

10. The video game controller according to claim 8, wherein said LED is electrically connected to a voltage source disposed within said hand held body.

11. The video game controller according to claim 10, further comprising a switch electrically connected to said LED to selectively connect said LED to said voltage source.

12. The video game controller according to claim 1, further comprising a vibrating device activated in response to a frequency response signal for applying soothing and stimulating vibrations to a body of a user; wherein said at least one indicator light is further illuminated in response to said frequency response signal.

13. The video game controller according to claim 12, wherein said at least one indicator light blinks in response to said frequency response signal.

14. A video game controller for interaction with a computer gaming unit, said controller comprising:
a hand held body;
a plurality of buttons logistically positioned for manipulation by a user;
at least one communication cable operatively connected to said hand held body and provided to transmit operation commands to said computer gaming unit in response to manipulation of said operation members by said user;
a vibrating device activated in response to a frequency response signal for applying soothing and stimulating vibrations to a body of a user; and
at least one indicator light illuminating in response to said frequency response signal,
wherein said at least one indicator light is disposed in said hand held body.

15. The video game controller according to claim 14, wherein said at least one indicator light is disposed beneath an exposed translucent material such that when said indicator light is illuminated, said light is visible to a user through said translucent material.

16. The video game controller according to claim 15, wherein said translucent material is one of a clear translucent material and non-clear translucent material.

17. The video game controller according to claim 15, wherein said translucent material is formed integrally with an external surface of said hand held body of said video game controller.

18. The video game controller according to claim 15, wherein said at least one indicator light is an LED visible through said translucent material.

19. The video game controller according to claim 15, wherein said translucent material is a colored translucent material.

20. The video game controller according to claim 14, wherein said at least one indicator light blinks in response to said frequency response signal.
